(19) United States
(12) Patent Application Publication
(10) Pub. No.: US 2007/0097970 A1
(43) Pub. Date: May 3, 2007

(54) PACKET RETRANSMITTER

(76) Inventor: Georgios Margaritis, Los Altos, CA (US)

Correspondence Address: Georgios Margaritis, 370 Verano Drive, Los Altos, CA, 94022, US

(21) Appl. No.: 11/554,083

(22) Filed: Oct. 30, 2006

Related U.S. Application Data
(60) Provisional application No. 60/732,427, filed on Nov. 1, 2005.

(51) Int. Cl. H04L 12/56; H04J 3/26

(52) U.S. Cl. 370/390; 370/432

(57) ABSTRACT

In this invention a novel method is disclosed for transmitting data from a server to a plurality of clients in a network that uses a novel network apparatus, called a packet retransmitter. A packet retransmitter is associated with a list of clients and makes that list available to a server in the network. When the server receives from at least two clients on the list a request for the same data, it responds by sending one copy of the data to the packet retransmitter. The packet retransmitters then makes copies of the data and sends a copy to each one of the requesting clients. The exchange of commands and data between the server and the packet retransmitter is accomplished by means of novel packets where a field in the packet is reserved for exchange of commands between the server and the packet retransmitter. A network architecture that includes a cascade of packet retransmitters is also disclosed wherein a first packet retransmitter connected to the server receives data from the server and then forwards them to a plurality of other packet retransmitters that either forward them to clients, or to other packet retransmitters until clients are reached.

This application claims the benefit of U.S. Provisional Application No. 60/732,427, filed on Nov. 1, 2005.

### FIELD OF THE INVENTION

The present invention relates to the field of Communication Networks and Network apparatuses.

### BACKGROUND OF THE INVENTION

The Internet is an electronic communications network that connects computers around the world. Each computer in the Internet is assigned a unique Internet protocol (IP) address to distinguish it from every other computer in the network. Data are exchanged between Internet computers by means of Internet protocol (IP) packets. An IP packet is a short section of data that is transmitted as a unit. FIG. 1a shows the structure of an IP packet. It includes an IP header and data.

In recent years, as the number of Internet computers has increased exponentially, so has the Internet network traffic. This has sometimes led to network traffic problems, such as slow connection speeds and poor transmitted data quality. Further, and in many occasions, such as a live broadcast of an event such as a concert, a computer in the Internet needs to send the same data to a multitude of other Internet computers. This could result in a large amount of traffic leaving the originating computer, potentially saturating the network capacity and causing network transmission problems.

In the present invention, a novel IP packet structure, a novel apparatus which is henceforth called a packet retransmitter, a novel network architecture and a broadcasting method are disclosed that can alleviate Internet traffic congestion problems.

### SUMMARY OF THE INVENTION

In this invention a novel method is disclosed for transmitting data from a server to a plurality of clients in a network that uses a novel network apparatus, called a packet retransmitter. Each packet retransmitter is associated with a list of clients and makes that list available to the server. When the server receives from two or more clients on the list a request for the same data, it responds by sending one copy of the data to the packet retransmitter. The packet retransmitters then makes multiple copies of the data and sends a copy to each one of the requesting clients. A novel packet architecture is also disclosed where a field in the packet is reserved for exchange of commands and information between the server and the packet retransmitter. A cascade of packet retransmitters could also be used, wherein a first packet retransmitter connected to the server receives data from the server and then forwards them to a plurality of other packet retransmitters that either forward them to clients, or to other packet retransmitters until clients are reached.

### LIST OF FIGURES

FIG. 1a shows a standard IP Packet

FIG. 1b shows a query IP packet of this invention

FIG. 1c shows an address packet of this invention

FIG. 1d shows a data packet of this invention

FIG. 2 shows elements of the network of this invention

FIG. 3 shows, in block diagram form, the code that the packet retransmitter of this invention executes.

### DESCRIPTION OF THE INVENTION

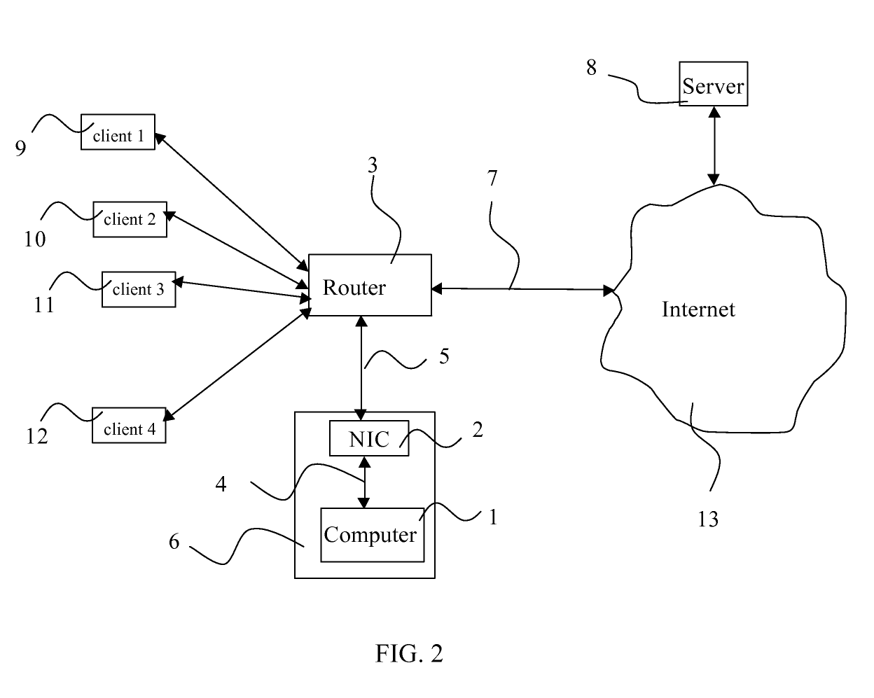

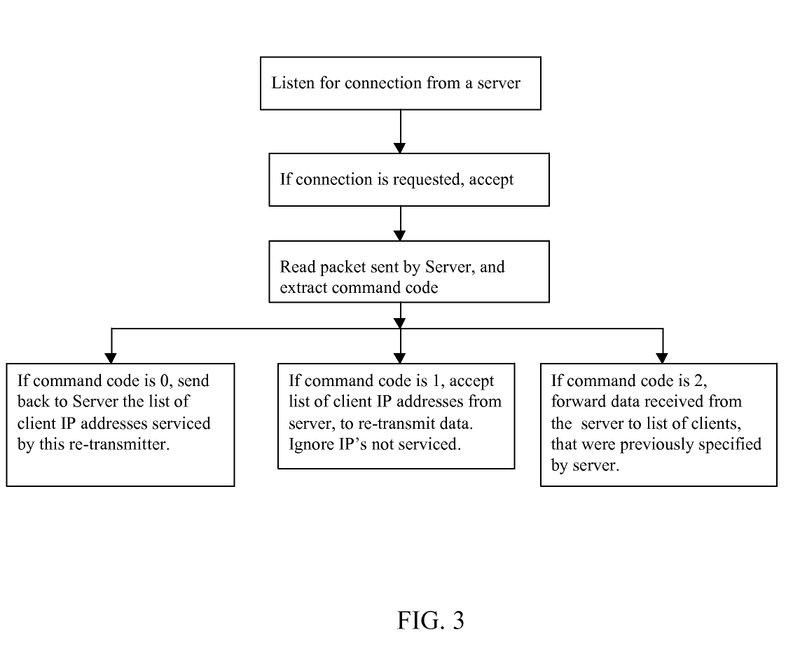

Referring to FIG. 2, one embodiment of the apparatus of this invention, henceforth called packet retransmitter, includes:
(i) A computer 1. In this embodiment an IBM compatible computer, running Windows NT 4.0 operating system, is used. It other embodiments, any other computer with networking capability could also be used, such as any Windows based PC with Networking capabilities, or a RISC based workstation or an Apple computer, running a networking capable Operating System such as Unix or Linux.
(ii) At least one network interface adapter (NIC) 2 installed in said computer. For example a D-Link PCI Fast Ethernet card attached to a PCI slot 4 of said computer, with all the appropriate drivers installed, can be used. It should be noted here that the network interface card 2 could also be implementing any other type of network communication protocol known to the Art such as a SONET OC-3, or an ATM DS3 protocol. The network interface card 2 is connected to a router 3, such as a BEFSR81 Linksys router, by means of a network cable 5. The router is also connected to a plurality of client computers 9, 10, 11, 12 through its Ethernet ports and to the Internet 13 through its DSL line. It is noted here that, in general, any number of client computers can be connected to a router. In other embodiments, the connections of the router to the NIC 2 and to the client computers 9 to 12, and to the Internet 13 could also be accomplished with fiber-optic or copper lines using, for example, Ethernet, SONET or ATM communication protocols.
(iii) The computer 1 is running computer code shown in block diagram form in FIG. 3. The block diagram of FIG. 3 relates to the transmission method described in the next paragraph. An example of such code written in Visual Basic is attached in APPENDIX A. The code is associated with a Visual Basic form, where a TextBox control called TxtOutput and two Winsock controls, called tcpReTx and Winsock1, were placed. In other embodiments, any other piece of software written in any programming language, such as Visual Basic, C, C++, Assembly language or machine code, that implements the tasks of the block diagram of FIG. 3 could also be used.

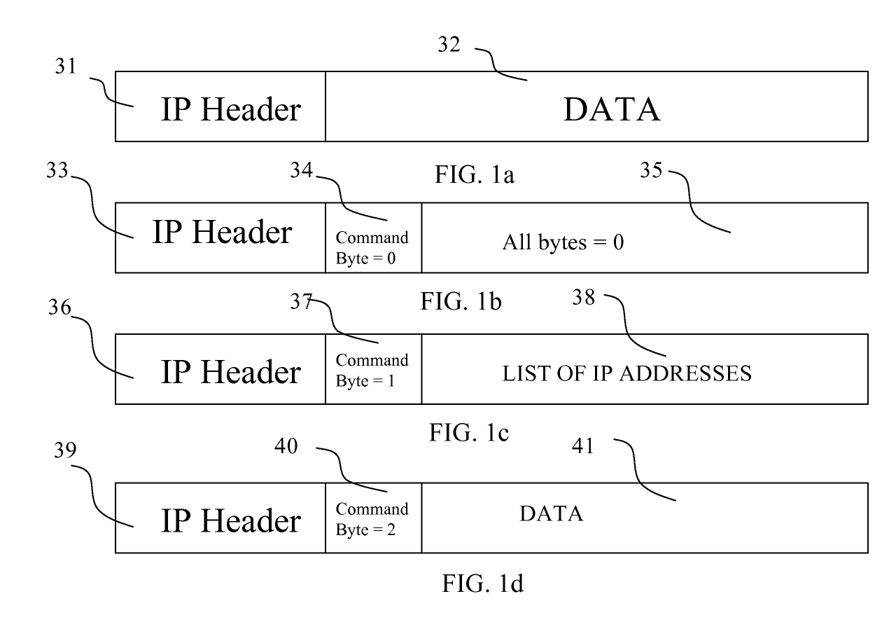

In the present invention, data are indirectly transmitted from a server computer 8 connected to the Internet 13 to a plurality of client computers 9, 10, 11, 12 also connected to the Internet 13, according to the following novel method:
(i) The client computers request from the server the same data, for example video feeds from a concert.
(ii) The server requests from the packet retransmitter 6 the IP addresses of all client computers associated with it. This is done by means of a query packet. FIG. 1b shows the structure of a query packet of the present invention. It has the same fields as a regular IP packet except that the first byte 34 of the data section henceforth called command byte, has the value 0. All other data bytes are set to zero. A list of packet retransmitters could have been entered into the server by a network operator, or by the server querying network devices to find which one responds as a packet retransmitter, or by the packet retransmitter querying the network for servers and notifying the serves found that it is a packet retransmitter.
(iii) When the IP packet retransmitter 6 receives the query packet, it sends back to the server 8 the IP addresses of all clients, 9 to 12, associated with it. This is done by means of an address packet. FIG. 1c shows the structure of an address packet of the present invention. It has the same fields as a regular IP packet except that the first byte 37 of the data section has the value 1. The remainder of the data section 38 of the packet contains the list of client IP addresses that will be receiving the data. Every set of four bytes that follows the command byte is the IP address of a client. The list of clients associated with the packet retransmitter can either be entered by an operator and stored in the packet retransmitter, or the packet retransmitter can dynamically identify the clients associated with it by using well known to the art address request packets (ARP's).
(iv) The server 8 then sends to the packet retransmitter 6 a list of clients that will be receiving the data. The server then starts sending the data to the packet retransmitter. This is done by means of data packets. FIG. 2d shows the structure of a data packet of the present invention. It has the same fields as a regular IP packet except that the first byte 40 of the data section has the value 2. The data 41 follow the command byte.
(v) The packet retransmitter 6 receives the data from the server 8.
(vi) The packet retransmitter 6 replicates the data and generates a separate IP packet for each client that is to receive the data.
(vii) The packet retransmitter 6 then sends the data to the clients 9 to 12.
(viii) The server 8 can change the list of clients receiving the transmission by sending a new address list to the packet retransmitter 6.
(ix) The server computer 8 must be running appropriate software code capable of generating, sending and receiving the IP packets of this invention. An example of such software code is shown in APPENDIX B. The code is associated with a Visual Basic form where two ListBox controls called ClientIP and RclientIP, two TextBox controls called PacketRetrIP and txtData, four CommandButton controls called SendQuery, SendIPList, cmdConnect, and SendData and one Winsock control called tcpServer were placed.
(x) The client computers 9 to 12 must also be running software code capable of establishing communications with the packet retransmitter 6 and receiving data. An example of such software code is shown in APPENDIX C. The code is associated with a Visual Basic form where a TextBox control called Text1 and a Winsock control called Winsock1 were placed.

Numerous other embodiments of the present invention are possible. For example, the packet retransmitter 6 could be embedded directly into the router 3, by means of a CPU, DSP, ASIC or FPGA embedded in the router running code that performs the functions of the packet retransmitter. The software instruction can be contained into a memory device, such as an SRAM chip, or could be mapped to a hardware configuration of an FPGA or an ASIC. Also, in other embodiments, the packet retransmitter of the present invention could be implement in other types of packet driven networks, such as Ethernet, ATM or SONET networks. For example, in an Ethernet based network, an Ethernet switch is used instead of the router, and Ethernet frames are used instead of IP packets. Also, in other embodiments, additional commands can be implemented by adding more command codes and possibly expanding the command portion of the IP packets of this invention to two or more bytes. Further, in other embodiments, a cascade of packet retransmitters could also be used, where a first packet retransmitter connected to the original server receives data from the server and then forwards them to a plurality of other packet retransmitters that either forward them to clients, or to other packet retransmitters until clients are reached. In general, a packet retransmitter replicates data received from a sending device, that can be a server or a higher level packet retransmitter to a plurality of recipient devices, that can be other packet retransmitters or clients. In other embodiments, the clients send the request for data to the packet retransmitter and the packet retransmitter forwards it to the server.

APPENDIX A

```
Dim ClientIP(1000) As String ‘ IPs of client computers
Dim ClientNum As Integer ‘ Number of clients
Dim RClientIP(1000) As String ‘ List of clients to receive transmission
Dim RClientNum As Integer ‘ Number of clients to receive transmission
Dim WinSockC(10) As Winsock
Private Sub Form_Load( )
  ‘ Set the LocalPort property to an integer.
  ‘ Then invoke the Listen method.
  tcpReTx.LocalPort = 1002
  tcpReTx.Listen
  ClientNum = 4
  ClientIP(1) = “63.195.65.114”
  ClientIP(2) = “63.195.65.115”
  ClientIP(3) = “63.195.65.116”
  ClientIP(4) = “63.195.65.117”
End Sub
Private Sub tcpReTx_ConnectionRequest _{—}
(ByVal requestID As Long)
  ‘ Check if the control's State is closed. If not,
  ‘ close the connection before accepting the new
  ‘ connection.
  If tcpReTx.State <> sckClosed Then _{—}
  tcpReTx.Close
  ‘ Accept the request with the requestID
  ‘ parameter.
  tcpReTx.Accept requestID
End Sub
‘ This function returns the character code for an ASCI character
Function GetInt(Val)
  For i = 1 To 255
    If (Val = Chr(i)) Then
      GetInt = i
    End If
  Next i
End Function
Private Sub tcpReTx_DataArrival _{—}
(ByVal bytesTotal As Long)
  ‘ Declare a variable for the incoming data.
  ‘ Invoke the GetData method and set the Text
  ‘ property of a TextBox named txtOutput to
  ‘ the data.
  Dim strData As String
  Dim Command As String ‘ This is the command code
  Dim StrAr As Variant
  ‘ Collect incoming data
  tcpReTx.GetData strData
  ‘ Extract command code from data
  Command = Left(strData, 1)
  If (Command = 0) Then ‘ This is a Query
    ‘ Return Client IP's
    strData = “”
    ‘ Enter command byte
    strData = strData + “1”
    ‘Enter number of Clients associated with this Packet retransmitter
    StrAr = CStr(ClientNum)
    SLen = Len(StrAr)
    If (SLen = 1) Then
      StrAr = “000” + StrAr
    ElseIf (SLen = 2) Then
      StrAr = “00” + StrAr
    ElseIf (SLen = 3) Then
      StrAr = “0” + StrAr
    End If
    strData = strData + StrAr
    ‘ Now add Client IPs
    For i = 1 To ClientNum
      StrAr = “”
      StrAr = Split(ClientIP(i), “.”)
      For j = 1 To 4
        strData = strData + Chr(CInt(StrAr(j − 1)))
      Next j
    Next i
    tcpReTx.SendData strData
  End If
  If (Command = 1) Then ‘ This is an Address List
    ‘ Get number of Clients that will receive the transmission
    RClientNum = CInt(Mid(strData, 2, 4))
    ‘ Get Client IP's that will receive the transmission
    strData = Mid(strData, 6, bytesTotal − 5)
    For i = 1 To RClientNum
      StrAr = “” ‘ Initialize String
      K = (i − 1) * 4
      For j = 1 To 4
        If (j < 4) Then
          StrAr = StrAr + CStr(GetInt(Mid(strData, K + j, 1))) + “.”
        Else
          StrAr = StrAr + CStr(GetInt(Mid(strData, K + j, 1)))
        End If
      Next j
      RClientIP(i) = StrAr
      TxtOutput.Text = TxtOutput.Text + StrAr + “ ”
      ‘ Connect to each requested Client IP Address and Port
      With Winsock1
        .RemoteHost = RClientIP(i)
        .RemotePort = 1003
      ‘ Connect
        .Connect
      End With
    Next i
  End If
  If (Command = 2) Then ‘ This is Data
    ‘ Get Data
    strData = Right(strData, bytesTotal − 1)
    For i = 1 To RClientNum ‘ For every client
      With Winsock1
      ‘ Send Data
        .SendData strData
      End With
    Next i
  End If
End Sub
```

APPENDIX B

```
Dim SClientIP(1000) As String
Dim SClientNum As Integer
Private Sub ClientIP_DblClick( )
  SClientNum = SClientNum + 1
  SClientIP(SClientNum) = ClientIP.Text
  RClientIP.AddItem (ClientIP.Text)
End Sub
Private Sub cmdConnect_Click( )
  tcpServer.RemoteHost = PacketRetrIP
  tcpServer.RemotePort = 1002
  tcpServer.Connect
End Sub
Private Sub Form_Load( )
  ClientNum = 0
End Sub
Private Sub SendData_Click( )
  Dim strData As String
  strData = “2”
  strData = strData + txtData
  tcpServer.SendData strData
End Sub
Private Sub SendIPList_Click( )
  Dim strData As String
  Dim StrAr As Variant
  ‘ Return Client IP's
  strData = “”
  ‘ Enter command byte
  strData = strData + “1”
  ‘Enter number of Clients associated with this Packet retransmitter
  StrAr = CStr(SClientNum)
  SLen = Len(StrAr)
  If (SLen = 1) Then
    StrAr = “000” + StrAr
  ElseIf (SLen = 2) Then
    StrAr = “00” + StrAr
  ElseIf (SLen = 3) Then
    StrAr = “0” + StrAr
  End If
  strData = strData + StrAr
  ‘ Now add Client IPs
  For i = 1 To SClientNum
    StrAr = “”
    StrAr = Split(SClientIP(i), “.”)
    For j = 1 To 4
      strData = strData + Chr(CInt(StrAr(j − 1)))
    Next j
  Next i
  tcpServer.SendData strData
End Sub
Private Sub SendQuery_Click( )
  Dim strData As String
  strData = “0”
  tcpServer.SendData strData
End Sub
‘ This function returns the character code for an ASCI character
Function GetInt(Val)
  For i = 1 To 255
    If (Val = Chr(i)) Then
      GetInt = i
    End If
  Next i
End Function
Private Sub tcpServer_DataArrival _{—}
(ByVal bytesTotal As Long)
  Dim strData As String
  Dim Command As String ‘ This is the command code
  Dim StrAr As Variant
  ‘ Collect incoming data
  tcpServer.GetData strData
  ‘ Extract command code from data
  Command = Left(strData, 1)
  Dim RClientIP(1000) As String ‘ List of clients to receive transmission
  Dim RClientNum As Integer ‘ Number of clients to receive
  transmission
  If (Command = 1) Then ‘ This is an Address List
    ‘ Get number of Clients that will receive the transmission
    RClientNum = CInt(Mid(strData, 2, 4))
    ‘ Get Client IP's that can receive the transmission
    strData = Mid(strData, 6, bytesTotal − 5)
    For i = 1 To RClientNum
      StrAr = “” ‘ Initialize String
      K = (i − 1) * 4
      For j = 1 To 4
        If (j < 4) Then
          StrAr = StrAr + CStr(GetInt(Mid(strData, K + j, 1))) + “.”
        Else
          StrAr = StrAr + CStr(GetInt(Mid(strData, K + j, 1)))
        End If
      Next j
      RClientIP(i) = StrAr
      ClientIP.AddItem (RClientIP(i))
    Next i
  End If
End Sub
```

APPENDIX C

```
Private Sub Winsock1_ConnectionRequest(ByVal requestID As Long)
  ‘ Check if the control's State is closed. If not,
  ‘ close the connection before accepting the new
  ‘ connection.
  If Winsock1.State <> sckClosed Then _{—}
  Winsock1.Close
  ‘ Accept the request with the requestID
  ‘ parameter.
  Winsock1.Accept requestID
End Sub
Private Sub Winsock1_DataArrival(ByVal bytesTotal As Long)
  ‘ Declare a variable for the incoming data.
  ‘ Invoke the GetData method and set the Text
  ‘ property of a TextBox named txtOutput to
  ‘ the data.
  Dim strData As String
  ‘ Collect incoming data
  Winsock1.GetData strData
  Text1.Text = strData
End Sub
Private Sub Form_Load( )
  ‘ Set the LocalPort property to an integer.
  ‘ Then invoke the Listen method.
  Winsock1.LocalPort = 1003
  Winsock1.Listen
End Sub
```

I claim:

1. An apparatus comprising:
a. network connection means for connecting to a packet driven network, and
b. packet replication means for replicating the data of incoming data packets and generating a plurality of new packets that are transmitted to specific recipient devices connected to the network.

2. The apparatus of claim 1 wherein said packet replicating means includes a device selected from the group consisting of CPU, FPGA, ASIC and DSP.

3. The apparatus of claim 2 further comprising a router.

4. The apparatus of claim 2 further comprising a switch.

5. The apparatus of claim 2 further comprising software instructions contained in a memory device.

6. A method for transmitting data from a server to a plurality of clients in a packet driven network comprising the steps of:
a. the clients requesting data from the server,
b. the server transmitting, either directly or indirectly through intermediate packet retransmitters, a copy of the data to a packet retransmitter in the network associated with said clients,
c. the packet retransmitter replicating the data and generating a plurality of new packets addressed to the clients, and
d. the packet retransmitter transmitting the new packets to the clients.

7. The method of claim 6 wherein the packets conform to the Internet protocol.

8. The method of claim 6 wherein the packets conform to the Ethernet protocol.

9. The method of claim 6 wherein the packets conform to the SONET protocol.

10. The method of claim 6 wherein the packets conform to the ATM protocol.

11. A network packet comprising a field that contains specific information to be exchanged between a server and a packet retransmitter.
